(19) United States
(12) Patent Application Publication
(10) Pub. No.: US 2013/0081883 A1
(43) Pub. Date: Apr. 4, 2013

(54) METHOD OF DISPLAYING WEIGHT OF VEHICLE AND PRESSURE IN TIRES ON ONE DISPLAY UNIT

(71) Applicant: Cheol Ho YANG, Yongin-si (KR)

(72) Inventor: Cheol Ho YANG, Yongin-si (KR)

(21) Appl. No.: 13/626,905

(22) Filed: Sep. 26, 2012

(30) Foreign Application Priority Data
Sep. 30, 2011 (KR) 10-2011-0100274

(51) Int. Cl. B60C 23/04; G01G 19/08

(52) U.S. Cl. 177/1

(57) ABSTRACT

Disclosed is a method of displaying weight of a vehicle and pressure in tires on one display unit, and more specifically, a method of displaying weight of a vehicle and pressure in tires on one display unit, in which the weight of a vehicle is measured based on pressure values of air suspensions. The weight of a vehicle is measured precisely by compensating properties of the material of the air suspension according to temperature. Pressure values of the tires and the compensated weight of the vehicle are displayed on one display unit, an actual weight is measured more precisely compared with conventional methods.

### BACKGROUND OF THE INVENTION

1. Field of the Invention

The present invention relates to a method of displaying weight of a vehicle and pressure in tires on one display unit, and more specifically, to a method of displaying weight of a vehicle and pressure in tires on one display unit, in which the weight of a vehicle is measured based on pressure values of air suspensions. The weight of a vehicle can be measured precisely by compensating properties of the material of the air suspension according to temperature. Since pressure values of the tires and the compensated weight of the vehicle are displayed on one display unit, an actual weight can be measured more precisely compared with conventional methods, and furthermore, cost for confirming the pressure and weight can be reduced.

2. Background of the Related Art

Generally, since driving an overloaded vehicle works as a factor of damages on roads, bridge structures and like, it shortens the endurance period of a road, and maintenance cost is increased. In addition, since excessive weight of the vehicle drops controllability and braking capability, it may cause a serious traffic accident.

In addition, since driving performance of the overloaded vehicle is relatively low, capacity of roads is decreased, and it works as a factor of environmental contamination around the roads since noises are generated and exhaust gases are discharged when the vehicle drives.

Control and measurement methods adopting a variety of systems are used in order to prevent such bad effects caused by overload, and most of the methods adopt a fixed-type axle-load measurement system which measures weight of a vehicle by installing sensors on the surface of roads.

However, since most of the currently adopted overload measuring methods are executed in a weight measurement apparatus remote from a loading place, roads and structures are inevitably damaged due to the overload while a truck moves. Furthermore, if the loaded amount measured by the weight measurement apparatus placed at a remote site exceeds a standard, freight should be unloaded and re-examined after the truck moves to the loading place, and thus quite a large amount of time is required.

A measurement method capable of self-weighting a vehicle loaded with freight is used to solve the problem, and in the measurement method, a pressure sensor is provided at each air suspension, and the weight of the vehicle is calculated using measured pressure values.

FIG. 1 is a view showing a conventional method of measuring weight of a vehicle using a pressure sensor, and FIG. 2 is a graph showing measurement errors according to the convention measurement method.

As shown in the figures, in the conventional method of measuring a weight, air flows into a T-type connector 4 from an air suspension 1. A pressure sensor unit 5 connected to the T-type connector 4 measures air pressure inside the pressure sensor unit 5, which is changed by the air flowed into the T-type connector 4, and sends a signal to an external control unit through a sensor cable 6, and the control unit calculates weight of the vehicle in proportion to a value measured by the pressure sensor unit 5.

The pressure sensor unit 5 is provided at the air suspension 1 of each axle and measures weight of each axle, and then a total weight is calculated from the weight of axles.

However, since such an air suspension 1 is very sensitive to environment due to the characteristics of the material, its response time is slow, or an error occurs due to seasonal temperature changes, and thus set values are modified and applied to a program in order to correct the error.

For example, when difference of temperature outside the pressure sensor unit 5 or the air suspension 1 is considerably large as is in summer or winter, volumes of the air inside the air suspension 1 and the pressure sensor unit 5 are changed due to the difference of temperature. The change in volumes invites a pressure measurement error, and thus an error occurs in measuring an actual weight.

In addition, if air pressure in the air suspension 1 of the vehicle is changed due to vibration of the vehicle and external influences, initial values of the system should be set again. However, setting the initial values may also generate an error, and thus the actual weight of the vehicle is difficult to calculate, and reliability of the system is degraded as a result.

In addition, since the response time of a tire also slows down depending on the temperature or an error may occur in relation to the tire, air pressure in the air suspension 1 is affected thereby, and thus there is a problem in measuring the actual weight of the vehicle.

Furthermore, conventionally, pressure in the tires and pressure in the air suspensions are displayed separately, and a display unit is separately provided in order to display pressure in each tire and air suspension, and thus a large amount of cost is required for a user to confirm the weight of a vehicle.

### SUMMARY OF THE INVENTION

Therefore, the present invention has been made in view of the above problems, and it is an object of the present invention to provide a method of displaying weight of a vehicle and pressure in tires on one display unit. The method measures pressure in a tire using a pressure sensor, measures pressure in an air suspension using a pressure measurement means, measures ambient temperature using a temperature sensor, receives a characteristic value corresponding to a pressure value of the air suspension and a temperature value, and compensates the pressure value of the air suspension. Therefore, errors can be prevented or minimized by calculating an actual weight of the vehicle. In addition, the pressure values and the weight can be displayed on one display unit, and thus cost for confirming the pressure and weight can be reduced, and it is convenient to confirm the pressures and weight in real-time.

To accomplish the above object, according to one aspect of the present invention, there is provided a method of measuring pressure in tires and weight of a vehicle and displaying the measured pressure in tires and weight of the vehicle on one display unit, the method including: a step of preparing the vehicle provided with a pressure measurement means at one or more pairs of air suspensions in order to maintain a pressure balance between each axle and a body frame in the vehicle formed with a plurality of axles having one or more tires at both ends along the body frame, and provided with a pressure sensor at each tire; a tire pressure measurement step of measuring pressure in the tire of the vehicle using the pressure sensor; an air suspension pressure measurement step of measuring pressure in the air suspension using the pressure measurement means; a temperature measurement step of measuring ambient temperature using a temperature sensor when measuring the pressure in the tire and the air suspension; a weight calculation step of calculating the weight of the vehicle through a calculation unit using the pressure in the air suspension; and a display step of storing the weight of the vehicle and a pressure value of the tire calculated and transmitted to a control unit in memory and displaying the weight and the pressure value on one display unit.

Preferably, the method further includes, before the weight calculation step, a characteristic value providing step of being provided with a characteristic value corresponding to a pressure value of the air suspension measured by the pressure measurement means and a temperature value measured by the temperature sensor, from a characteristic value providing unit; and a compensation step of compensating the pressure value of the air suspension with the provided characteristic value by a compensation unit, in which the weight of the vehicle is calculated by applying the compensated pressure value of the air suspension.

Then, the method further includes the step of determining a parking state and a driving state of the vehicle by the control unit, in which the step of determining a parking state and a driving state of the vehicle further includes the steps of: receiving the pressure value of the pressure sensor or the pressure measurement means a plurality of times in a predetermined time period and sequentially comparing the pressure values; and determining the vehicle as being in a parking state if difference of the pressure values is within a predetermined range, and determining the vehicle as being in a driving state if the difference of the pressure values is out of the predetermined range.

In addition, the predetermined range of change in the pressure values is between absolute values of 0 to 0.1 psi.

Then, the method further includes the step of determining a parking state and a driving state of the vehicle by the control unit, in which a temperature sensor for measuring temperature of the tire is further provided, and the step of determining a parking state and a driving state of the vehicle further includes the steps of: comparing ambient temperature values and tire temperature values sequentially transmitted a plurality of times in a predetermined time period; and determining the vehicle as being in a parking state if difference between the ambient temperature value and the tire temperature value is within a predetermined range, and determining the vehicle as being in a driving state if the difference between the ambient temperature value and the tire temperature value is out of the predetermined range.

In addition, the predetermined range of temperature value is between absolute values of 0 to 5° C.

Then, the display unit is configured to display a pressure mode and a weight mode, in which the pressure mode displays any one ore more of the tire pressure value measured by the pressure sensor, the air suspension pressure value measured by the pressure measurement means and the temperature value measured by the temperature sensor, and the weight mode displays the weight of the vehicle.

In addition, the pressure mode and the weight mode are provided to display the tire pressure value, the air suspension pressure value, the temperature value, and the weight of the vehicle when the vehicle is in a parking state or a driving state, and if the weight mode is displayed while the vehicle is driving, a warning, not an actual weight, is displayed.

Then, the pressure measurement means is provided at an air intake portion and an air exhaustion portion of each air suspension, and pressure is measured at the air intake portion of the air suspension using the pressure measurement means provided at the air intake portion of the air suspension and at the air exhaustion portion of the air suspension using the pressure measurement means provided at the air exhaustion portion of the air suspension.

In addition, the method further includes the step of calculating the pressure value of the air suspension as an average value of the pressure measured in the step of measuring pressure at the air intake portion of the air suspension and the pressure measured in the step of measuring pressure at the air exhaustion portion of the air suspension.

Then, the characteristic value of the air suspension is a value of change in properties of the air suspension according to changes in temperature and weight.

In addition, the characteristic value of the air suspension measured at each predetermined temperature are expressed as a continuous curve, in which pressure values are measured by adding weight to each air suspension in steps, and the pressure values in each step of weight are curve-fitted.

### BRIEF DESCRIPTION OF THE DRAWINGS

FIG. 1 is a view showing a conventional method of measuring weight of a vehicle using a pressure sensor.

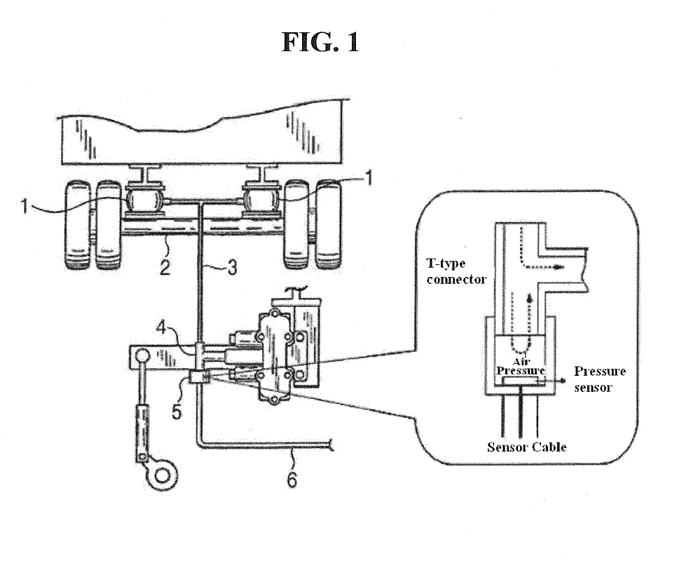

FIG. 2 is a graph showing measurement errors according to the convention measurement method.

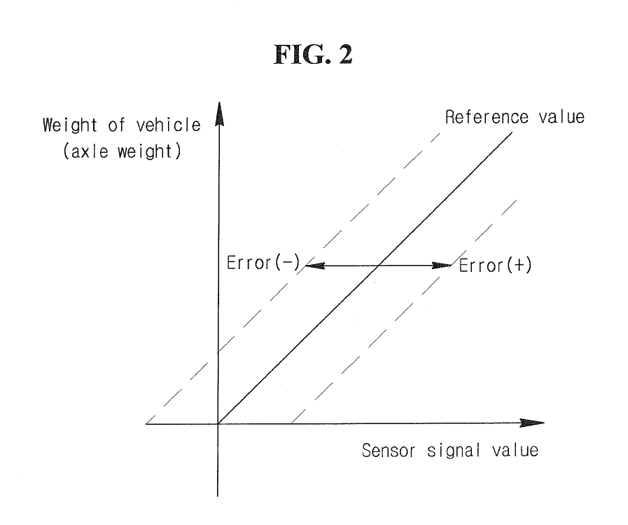

FIG. 3 is a view showing a method of displaying weight of a vehicle and pressure in tires on one display unit according to the present invention.

FIG. 4 is a view schematically showing an apparatus for measuring pressure in tires and weight of a vehicle according to the present invention.

FIG. 5 is a view showing a graph drawn using characteristic values according to the present invention.

### DESCRIPTION OF SYMBOLS

1: Air suspension 20: Tire

30: Pressure sensor 40, 300: Temperature sensor

100: Pressure measurement means

200: Characteristic value providing unit

400: Control unit 500: Display unit

600: Compensation unit 700: Calculation unit

800: Memory

### DETAILED DESCRIPTION OF THE PREFERRED EMBODIMENT

The preferred embodiments of the invention will be hereafter described in detail, with reference to the accompanying drawings.

Although the present invention is described with reference to several preferred embodiments, the description is illustrative of the invention and is not to be construed as limiting the invention. Various modifications and variations may occur to those skilled in the art, without departing from the scope of the invention as defined by the appended claims.

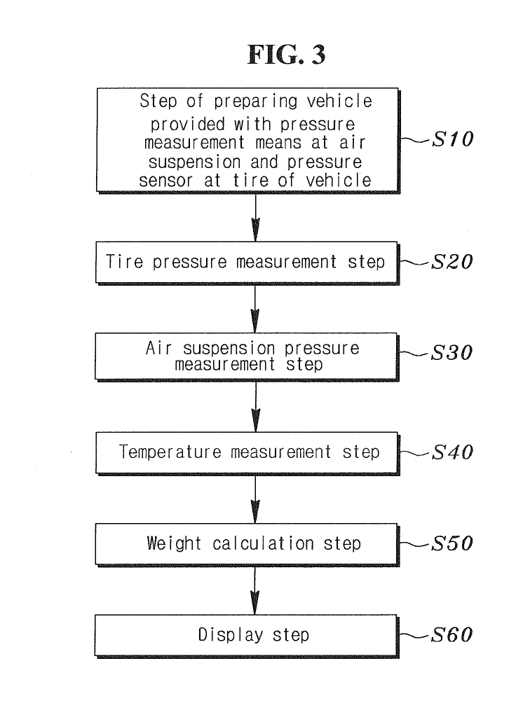

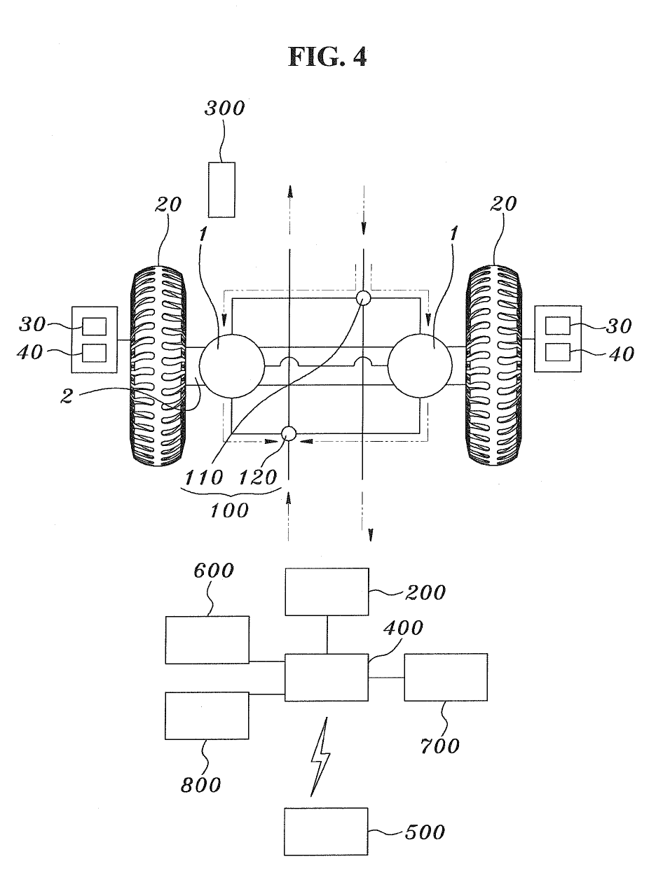

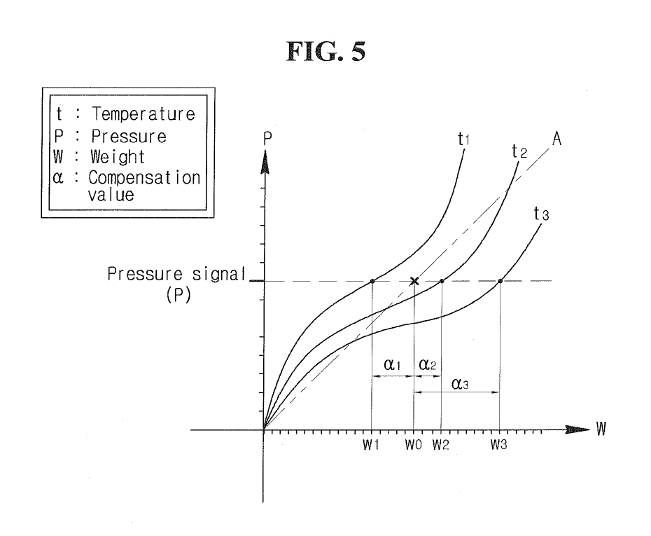

FIG. 3 is a view showing a method of displaying weight of a vehicle and pressure in tires on one display unit according to the present invention, FIG. 4 is a view schematically showing an apparatus for measuring pressure in tires and weight of a vehicle according to the present invention, and FIG. 5 is a view showing a graph drawn using characteristic values according to the present invention.

As shown in FIGS. 3 and 4, the method of displaying weight of a vehicle and pressure in tires on one display unit includes a step of preparing a vehicle provided with a pressure measurement means at an air suspension and a pressure sensor at a tire of the vehicle S10, a tire pressure measurement step S20, an air suspension pressure measurement step S30, a temperature measurement step S40, a weight calculation step S50 and a display step S60.

A plurality of axles is formed in the vehicle along the body frame, and one or more tires are installed at both ends of the axles.

One or more pairs of air suspensions 1 are provided between each axle and the body frame in order to maintain a pressure balance.

First, the step of preparing a vehicle provided with a pressure measurement means at an air suspension and a pressure sensor at a tire of the vehicle S10 prepares a vehicle provided with a pressure measurement means 100 at one or more pairs of air suspensions between each axle and the body frame in order to maintain a pressure balance, in the vehicle formed with a plurality of axles formed along the body frame and having one or more tires 20 at both ends, and the vehicle is provided with a pressure sensor 30 at each tire.

The tire pressure measurement step S20 measures pressure in the tire of the vehicle using the pressure sensor 30, and the air suspension pressure measurement step S30 measures pressure in the air suspension 1 using the pressure measurement means 100.

Here, the pressure measurement means 100 is provided at an air intake portion and an air exhaustion portion of each air suspension, and pressure is measured at the air intake portion of the air suspension using the pressure measurement means provided at the air intake portion of the air suspension and at the air exhaustion portion of the air suspension using the pressure measurement means provided at the air exhaustion portion of the air suspension.

To this end, the pressure measurement means 100 includes an intake pressure measurement means 110 and an exhaustion pressure measurement means 120, and pressure at the air intake portion and the air exhaustion portion of the air suspension 1 provided at each axle is measured by the intake pressure measurement means 110 and the exhaustion pressure measurement means 120.

At this point, a step of calculating a pressure value of the air suspension is further provided, and the pressure value of the air suspension is calculated as an average value of the pressure measured in the step of measuring pressure at the air intake portion of the air suspension and the pressure measured in the step of measuring pressure at the air exhaustion portion of the air suspension.

Accordingly, the pressure value of the air suspension is an average value of a pressure value measured by the intake pressure measurement means 110 provided at the air intake portion of the air suspension 1 and a pressure value measured by the exhaustion pressure measurement means 120 provided at the air exhaustion portion, and errors can be prevented and minimized thereby.

In addition, the temperature measurement step S40 measures ambient temperature using a temperature sensor 300 when the pressure in a tire and the pressure in an air suspension are measured, and the weight calculation step S50 calculates weight of the vehicle through a Calculation unit 700 using the pressure in the air suspension 1.

Here, the pressure sensor 30, the pressure measurement means 100 and the temperature sensor 300 transmit the measured values to a control unit 400 in real-time.

The control unit 400 further includes a step of determining a parking state and a driving state of the vehicle. The control unit 400 confirms a pressure value of a tire based on the pressure value of the tire transmitted in the parking state, and the Calculation unit 700 confirms weight of the vehicle based on the pressure value of the air suspension transmitted also in the parking state.

In an embodiment, the step of determining a parking state and a driving state of the vehicle further includes the steps of receiving a pressure value of the pressure sensor 30 or the pressure measurement means 100 a plurality of times in a predetermined time period and sequentially comparing the pressure values, determining the vehicle as being in a parking state if difference of the pressure values is within a predetermined range, and determining the vehicle as being in a driving state if the difference of the pressure values is out of the predetermined range.

Here, in an embodiment, the pressure values of the pressure sensor 30 or the pressure measurement means 100 are transmitted preferably five or more times in a predetermined time period, and the predetermined range of change in the pressure values is preferably between absolute values of 0 to 0.1 psi.

Meanwhile, a temperature sensor for measuring temperature of a tire is further provided in another embodiment, and the step of determining a parking state and a driving state of the vehicle further includes the steps of comparing ambient temperature values and tire temperature values sequentially transmitted a plurality of times in a predetermined time period, determining the vehicle as being in a parking state if difference between the ambient temperature value and the tire temperature value is within a predetermined range, and determining the vehicle as being in a driving state if the difference between the ambient temperature value and the tire temperature value is out of the predetermined range.

In an embodiment, the ambient temperature values and the tire temperature values are transmitted preferably five or more times in a predetermined time period, and the predetermined range of difference in the temperature values is preferably between absolute values of 0 to 5° C. If the difference in the temperature values is larger than 3 to 4° C., the vehicle is preferably determined as being in a driving state.

In addition, in another embodiment of a method of determining a parking or driving state by the control unit 400, pressure values of the pressure sensor 30 or the pressure measurement means 100 are received and sequentially compared a plurality of times in a predetermined time period, and ambient temperature values and tire temperature values are received and compared a plurality of times in a predetermined time period. If either a difference in the pressure values is within a predetermined range or a difference in the temperature values is within a predetermined range, the vehicle is determined as being in a parking state, and if the differences in the pressure values and the temperature values are out of the predetermined ranges, the vehicle is determined as being in a driving state.

Here, in an embodiment, the pressure values of the pressure sensor 30 or the pressure measurement means 100 are preferably transmitted five or more times in a predetermined time period, and the predetermined range of difference in the pressure values is preferably between absolute values of 0 to 0.1 psi.

The predetermined range of difference in the temperature values is preferably between absolute values of 0 to 5° C., and if the difference in the temperature values is larger than 3 to 4° C., the vehicle is preferably determined as being in a driving state.

Here, it is preferable that the control unit 400 determines the parking state based on pressure values, as well as temperature values.

It is since that a time taken for dropping an increased temperature value of a tire to a temperature similar to an ambient temperature value is longer than a time taken for dropping an increased pressure to a predetermined range of pressure value, and thus an error may occur in confirming a parking state of a vehicle.

However, if the range of change in the pressure values of the pressure sensor 30 or the pressure measurement means 100 is within a range corresponding to a parking state and the tire temperature value is different from the ambient temperature value, the parking state can be confirmed using the difference in the temperature values.

At this point, the control unit 400 compares the pressure values and the temperature values at regular time intervals. The time intervals are applied differently in each case, and a minimum unit of the time interval is preferably a second.

After storing the weight of the vehicle and the pressure values of the tires calculated and transmitted to the control unit 400 in memory 800, the display step S60 displays the weight and the pressure values on one display unit 500.

Here, the display unit 500 is configured to display a pressure mode and a weight mode. The pressure mode displays any one ore more of a tire pressure value, an air suspension pressure value and a temperature value, and the weight mode displays weight of the vehicle.

Accordingly, the only display unit 500 displays the pressure mode and the weight mode. The pressure mode displays any one ore more of a tire pressure value, an air suspension pressure value and a temperature value, and the weight mode displays weight of the vehicle.

At this point, the pressure mode and the weight mode are provided to display a tire pressure value, an air suspension pressure value, a temperature value, and weight of the vehicle when the vehicle is in a parking or driving state. If the weight mode is displayed while the vehicle is driving, a warning, not an actual weight, is displayed.

Therefore, a user may easily confirm whether or not the weight is an actual weight.

Here, a characteristic value providing step and a compensation step are further included before the weight calculation step S50, and in the characteristic value providing step, a characteristic value providing unit 200 provides a characteristic value corresponding to the pressure value of the air suspension and the temperature value.

In the compensation step, a compensation unit 600 compensates the pressure value of the air suspension with the received characteristic value.

First, the characteristic value providing step receives a characteristic value corresponding to the pressure value of air suspension 1 measured in the air suspension pressure measurement step S30 and the temperature value measured in the temperature measurement step S40 from the characteristic value providing unit 200.

Here, the characteristic value of the characteristic value providing step is a value of change in properties of the air suspension 1 according to changes in temperature and weight. Pressure values are measured by adding weight to each air suspension 1 in steps, and pressure values in the steps of weight are curve-fitted. The characteristic values measured at each predetermined temperature are expressed as a continuous curve.

Then, in the compensation step, the compensation unit 600 compensates the pressure value of the air suspension 1 using the received characteristic value.

The characteristic values can be confirmed by applying a plurality of known values at temperature values of t1, t2 and t3 and measuring pressure values corresponding to the known values.

For example, a known value (W1-1) is applied at a temperature of t1, and a pressure value (P1-1) corresponding to the known value (W1-1) is measured.

Then, another known value (W1-2) is applied, and a pressure value (P1-2) is measured.

In addition, still another known value (W1-n) is applied, and a pressure value (P1-n) is measured.

Accordingly, coordinate values {(W1-1, P1-1), (W1-2, P1-2), . . . , (W1-n, P1-n)} are obtained by confirming pressure values (P1-1 to P1-n) of a tire 20 corresponding to the known values (W1-1 to W1-n), and characteristic values corresponding to t1 are obtained by curve-fitting the coordinate values {(W1-1, P1-1), (W1-2, P1-2), . . . , (W1-n, P1-n)}.

Then, coordinate values {(W2-1, P2-1), (W2-2, P2-2), . . . , (W2-n, P2-n)} are obtained by confirming pressure values (P2-1 to P2-n) corresponding to the known values (W2-1 to W2-n) through a process the same as described above at a temperature of t2, and characteristic values corresponding to t2 are obtained by curve-fitting the coordinate values {(W2-1, P2-1), (W2-2, P2-2), . . . , (W2-n, P2-n)}.

In addition, coordinate values {(W3-1, P3-1), (W3-2, P3-2), . . . , (W3-n, P3-n)} are obtained by confirming pressure values (P3-1 to P3-n) corresponding to the known values (W3-1 to W3-n) through a process the same as described above at a temperature of t3, and characteristic values corresponding to t3 are obtained by curve-fitting the coordinate values {(W3-1, P3-1), (W3-2, P3-2), . . . , (W3-n, P3-n)}.

If unknown values W are applied after obtaining the characteristic values as described above and a compensated weight is obtained by the pressure values P and the characteristics values, a correct weight can be measured, and thus a weight free from all kinds of errors can be measured.

Here, the measured temperature values are only an example, and it is apparent that the temperature values are also set to t1 to tn, characteristic values corresponding to the temperature values can be obtained.

As described above, the characteristic value providing unit 200 stores the characteristic values corresponding to the temperature values t1, t2 and t3, and the control unit 400 may calculate an actual pressure value of the air suspension by receiving the characteristic values corresponding to the pressure value of the pressure sensor 30 and temperature value of the temperature sensor 40 from the characteristic value providing unit 200 and compensating the pressure value of the air suspension based on the characteristic values.

Describing the characteristic value compensation in detail with reference to FIG. 5, an actual pressure value of the air suspension can be calculated by receiving the characteristic values corresponding to pressure values P and temperature values t1, t2 and t3 and compensating the pressure values of the air suspension.

Here, although the temperature values are measured as t1, t2 and t3 in an embodiment, the number of measured temperatures is not limited, and a monthly average temperature in a region where the present invention is mainly used is preferably applied.

The characteristic value providing unit 200 provides characteristic values of a tire for each of the temperatures t1, t2 and t3 expressed as t1, t2 and t3.

There is provided an existing reference value A of a straight line which expresses the weight W calculated based on initially measured pressure P in a tire.

As described above, since an error occurs in such a reference value A due to the amount of changes in the properties of the tire 20, characteristic values of each tire 20 are provided.

Here, if the existing reference value A is compared with the characteristic values of the tire, a weight W0 is calculated based on the existing reference value A with respect to the measured pressure value P.

Then, if the characteristic values of the tire are compared with respect to the measured pressure values P, weights W1, W2 and W3 are calculated using the characteristic values of the tire for each of temperatures t1, t2 and t3 of an embodiment.

At this point, difference in W1, W2 and W3 can be confirmed based on the existing weight W0.

Such a difference is referred to as a compensation value α, and the error can be corrected as much as a compensation value α1 between W0 and W1, a compensation value α2 between W0 and W2, and a compensation value α3 between W0 and W3.

Here, the weights W1, W2 and W3 represent pressure values of the air suspension corrected based on the characteristic values.

Since such characteristic values are provided by the characteristic value providing unit 200, changes in the inherent properties occurred by the characteristics of an original material having elasticity such as a rubber or the like or a molding process can be compensated, and thus errors in the pressure values of the air suspension 1 can be prevented and minimized.

In the weight calculation step S50, weight of a vehicle is calculated by applying the pressure value of the air suspension compensated through the characteristic value providing step and the compensation step, and thus a weight can be precisely measured by preventing and minimizing the conventionally occurred errors.

As described above, according to the method of displaying weight of a vehicle and pressure in tires on one display unit, an actual weight of the vehicle can be calculated by compensating a pressure value of the air suspension with a characteristic value corresponding to a temperature value, and the pressure values of the tires and the weight of the vehicle can be displayed on one display unit, and thus cost for confirming the pressure and weight can be reduced while providing convenience.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

1. A method of measuring pressure in tires and weight of a vehicle and displaying the measured pressure in tires and weight of the vehicle on one display unit, the method comprising:
a step of preparing the vehicle provided with a pressure measurement means at one or more pairs of air suspensions in order to maintain a pressure balance between each axle and a body frame in the vehicle formed with a plurality of axles having one or more tires at both ends along the body frame, and provided with a pressure sensor at each tire;
a tire pressure measurement step of measuring pressure in the tire of the vehicle using the pressure sensor;
an air suspension pressure measurement step of measuring pressure in the air suspension using the pressure measurement means;
a temperature measurement step of measuring ambient temperature using a temperature sensor when measuring the pressure in the tire and the air suspension;
a weight calculation step of calculating the weight of the vehicle through a calculation unit using the pressure in the air suspension; and
a display step of storing the weight of the vehicle and a pressure value of the tire calculated and transmitted to a control unit in memory and displaying the weight and the pressure value on one display unit, wherein
the display unit is configured to display a pressure mode and a weight mode, wherein
the pressure mode displays at least one of the tire pressure value measured by the pressure sensor, an air suspension pressure value measured by the pressure measurement means and a temperature value measured by the temperature sensor, and the weight mode displays the weight of the vehicle.

2. The method according to claim 1, further comprising, before the weight calculation step,
a characteristic value providing step of being provided with a characteristic value corresponding to a pressure value of the air suspension measured by the pressure measurement means and a temperature value measured by the temperature sensor, from a characteristic value providing unit; and
a compensation step of compensating the pressure value of the air suspension with the provided characteristic value by a compensation unit, wherein
the weight of the vehicle is calculated by applying the compensated pressure value of the air suspension.

3. The method according to claim 1, further comprising the step of determining a parking state and a driving state of the vehicle by the control unit, wherein
the step of determining a parking state and a driving state of the vehicle further includes the steps of:
receiving the pressure value of the pressure sensor or the pressure measurement means a plurality of times in a predetermined time period and sequentially comparing the pressure values; and
determining the vehicle as being in a parking state if difference of the pressure values is within a predetermined range, and determining the vehicle as being in a driving state if the difference of the pressure values is out of the predetermined range.

4. The method according to claim 3, wherein the predetermined range of change in the pressure values is between absolute values of 0 to 0.1 psi.

5. The method according to claim 1, further comprising the step of determining a parking state and a driving state of the vehicle by the control unit, wherein
a temperature sensor for measuring temperature of the tire is further provided, and
the step of determining a parking state and a driving state of the vehicle further includes the steps of:
comparing ambient temperature values and tire temperature values sequentially transmitted a plurality of times in a predetermined time period; and
determining the vehicle as being in a parking state if difference between the ambient temperature value and the tire temperature value is within a predetermined range, and determining the vehicle as being in a driving state if the difference between the ambient temperature value and the tire temperature value is out of the predetermined range.

6. The method according to claim 5, wherein the predetermined range of temperature value is between absolute values of 0 to 5° C.

7. The method according to claim 1, wherein the pressure mode and the weight mode are provided to display a tire pressure value, an air suspension pressure value, a temperature value, and the weight of the vehicle when the vehicle is in a parking state or a driving state, and if the weight mode is displayed while the vehicle is driving, a warning, not an actual weight, is displayed.

8. The method according to claim 1, wherein the pressure measurement means is provided at an air intake portion and an air exhaustion portion of each air suspension, and pressure is measured at the air intake portion of the air suspension using the pressure measurement means provided at the air intake portion of the air suspension and at the air exhaustion portion of the air suspension using the pressure measurement means provided at the air exhaustion portion of the air suspension.

9. The method according to claim 8, further comprising the step of calculating the pressure value of the air suspension as an average value of the pressure measured in the step of measuring pressure at the air intake portion of the air suspension and the pressure measured in the step of measuring pressure at the air exhaustion portion of the air suspension.

10. The method according to claim 2, wherein the characteristic value of the air suspension is a value of change in properties of the air suspension according to changes in temperature and weight.

11. The method according to claim 2, wherein the characteristic value of the air suspension measured at each predetermined temperature are expressed as a continuous curve, wherein pressure values are measured by adding weight to each air suspension in steps, and the pressure values in each step of weight are curve-fitted.
